(19) United States
(12) Patent Application Publication
(10) Pub. No.: US 2009/0059792 A1
(43) Pub. Date: Mar. 5, 2009

(54) Wireless Communication Device, Wireless Communication System, Wireless Communication Method, and Program

(76) Inventor: Katsutoshi ITOH, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/201,813

(22) Filed: Aug. 29, 2008

(30) Foreign Application Priority Data
Aug. 30, 2007 (JP) P2007-223747

(51) Int. Cl. H04J 1/16; H04W 4/00

(52) U.S. Cl. 370/235; 370/338; 370/477

(57) ABSTRACT

A bandwidth-reservation wireless communication device that performs communication with a communication destination node connected thereto via a wireless communication network includes a traffic amount estimation unit configured to estimate an amount of traffic involved in receiving response data from the communication destination node, and a media resources reservation unit configured to reserve media resources on the basis of the estimated amount of traffic.

### CROSS REFERENCES TO RELATED APPLICATIONS

The present invention contains subject matter related to Japanese Patent Application JP 2007-223747 filed in the Japanese Patent Office on Aug. 30, 2007, the entire contents of which are incorporated herein by reference.

### BACKGROUND OF THE INVENTION

1. Field of the Invention

The present invention relates to a wireless communication device, a wireless communication system, a wireless communication method, and a program.

2. Description of the Related Art

In a carrier sense multiple access with collision avoidance (CSMA/CA) protocol such as IEEE 802.11 for wireless local area network (WLAN) communications, a procedure of detection of the availability of a medium (wireless transmission channel), contention of media access with other nodes, media resources reservation (allocation), data transmission, and detection of retransmission request is repeated to transmit and receive data.

FIG. 15 is a timing chart showing how data transmission and reception are performed according to the CSMA/CA protocol. First, a transmitting node or station STA-A transmits a request-to-send (RTS) signal indicating that communication is available, and receives a clear-to-send (CTS) signal indicating the permission of transmission from a receiving node or station STA-B. Thus, the reservation of media resources is performed. Afterwards, data (Data to B) is sent from the node STA-A to the node STA-B, and an acknowledgement (ACK) is returned from the node STA-B to the node STA-A to notify the node STA-A of successful reception of the data.

Thereafter, the node STA-B senses a channel, and transmits an RTS signal to the node STA-A. Upon receiving a CTS signal, the node STA-B reserves media resources. Then, data (Data to A) is transmitted from the node STA-B to the node STA-A, and an ACK is received from the node STA-A.

The technique described above provides simple control of data transmission and reception although problems in causing throughput degradation may occur due to the following reasons:

(1) The overhead, in terms of time, involved in the process of detecting the availability of media resources and involved in equally assigning media access privileges to other nodes is high. Thus, transmissions from a plurality of nodes are concentrated on an identical node, and packet collision may occur due to the non-integrity of the mechanism.

(2) The overhead of the protocol involved in the reservation of media resources is high.

(3) Due to the lack of the capability of recognizing the transmission performance of media, the transmitter is not able to select an optimum data packet transmission rate.

In view of such a situation, in IEEE 802.11n, a reverse direction protocol for reducing the overhead involved for bi-directional data communication between nodes and the packet collision probability is specified.

### SUMMARY OF THE INVENTION

However, there are problems with a technique based on the reverse direction protocol in that the node STA-A is not capable of detecting media resources (the presence of data, the amount of data, and the available transmission rate) necessary for the node STA-B. Since it is difficult to determine the amount of media resources to be reserved during the reservation of media resources, a greater amount of media resources than an actually used amount of media resources may be reserved. Even if an excessive amount of media resources are reserved, no penalty is imposed. Thus, such reservation of media resources would, by itself, reduce the number of transmission opportunities of other nodes.

It is therefore desirable to provide a novel and improved wireless communication device, wireless communication system, wireless communication method, and program in which a transmitter reserves a minimum amount of media resources to ensure that transmission opportunities can equally be assigned to nodes within a network.

According to an embodiment of the present invention, a bandwidth-reservation wireless communication device that performs communication with a communication destination node connected thereto via a wireless communication network includes a traffic amount estimation unit configured to estimate an amount of traffic involved in receiving response data from the communication destination node, and a media resources reservation unit configured to reserve media resources on the basis of the estimated amount of traffic.

With this structure, an amount of traffic involved in receiving response data from a communication destination node is estimated and media resources are reserved on the basis of the amount of traffic. Therefore, a minimum amount of media resources can be reserved according to response data from the communication destination node. This can prevent a greater amount of media resources than an actually used amount of media resources from being reserved, and can reliably prevent a reduction in the number of transmission opportunities of other nodes.

The wireless communication device may further include a transmission-data amount calculation unit configured to calculate an amount of transmission data to be transmitted to the communication destination node, an average transmission rate calculation unit configured to calculate an average transmission rate during transmission, and a media resources calculation unit configured to calculate a media resources reservation time on the basis of the amount of traffic, the amount of transmission data, and the average transmission rate, and the media resources reservation unit may reserve media resources on the basis of the media resources reservation time calculated by the media resources calculation unit. With this structure, a media resources reservation time is calculated based on an amount of traffic involved in receiving response data, an amount of transmission data to be transmitted to the communication destination node, and an average transmission rate during transmission, and media resources are reserved on the basis of the media resources reservation time. Therefore, media resources can be reserved by taking the amount of traffic involved in receiving response data and the amount of media resources necessary for data transmission into account.

The wireless communication device may receive an acknowledgement in response to data transmitted to the communication destination node, and the response data from the communication destination node. With this structure, a device that receives an acknowledgement (ACK) based on the reverse direction protocol in IEEE 801.11n and response data can estimate an amount of traffic involved in receiving the response data.

The traffic amount estimation unit may estimate the amount of traffic on the basis of a request value transmitted from the communication destination node. With this structure, media resources can be reserved on the basis of a request value transmitted from the communication destination node.

The traffic amount estimation unit may estimate the amount of traffic on the basis of information transmitted from an application layer higher than a Media Access Control (MAC) layer. With this structure, the amount of traffic can be accurately estimated on the basis of information transmitted from an application layer higher than the MAC layer.

The application layer may be a Transmission Control Protocol layer, and the traffic amount estimation unit may estimate the amount of traffic on the basis of a remaining capacity of a Transmission Control Protocol buffer included in the communication destination node. With this structure, when the TCP buffer of the communication destination node has a small remaining capacity, the returning of data from the communication destination node is predictable. The amount of traffic can thus be estimated on the basis of the remaining capacity of the TCP buffer.

The traffic amount estimation unit may calculate the remaining capacity of the Transmission Control Protocol buffer included in the communication destination node using a difference between a window size of the Transmission Control Protocol buffer and an amount of transmission data transmitted to the communication destination node in response to which an acknowledgement has not been returned. With this structure, the remaining capacity of the TCP buffer of the communication destination node can be calculated from the difference between the window size of the TCP buffer and the amount of transmission data transmitted to the communication destination node in response to which an acknowledgement (ACK) has not been returned. Therefore, the amount of traffic can be estimated on the basis of the remaining capacity of the TCP buffer.

The traffic amount estimation unit may estimate the amount of traffic according to an amount of transmission data to be transmitted to the communication destination node and a type of a communication application detected by the application layer. With this structure, the amount of traffic can be estimated according to the amount of transmission data to be transmitted to the communication destination node and the type of the communication application detected by the application layer.

The traffic amount estimation unit may calculate the amount of traffic by multiplying the amount of transmission data to be transmitted to the communication destination node by a coefficient that is set according to the type of the communication application. With this structure, the amount of traffic can be determined according to the coefficient set according to the type of the communication application.

The media resources reservation unit may include a media-resources-used-time management unit configured to manage a media resources used time involved from the start of use of the media resources. The media-resources-used-time management unit may add the media resources reservation time to the media resources used time to update the media resources used time, and may adjust an amount by which the media resources reservation time is added to the media resources used time according to a load placed on the wireless communication network. With this structure, the media resources reservation time is added to the media resources used time to update the media resources used time, and the amount by which the media resources reservation time is added is adjusted according to a load placed on the wireless communication network. Therefore, the media resources used time can be adjusted according to the load placed on the wireless communication network and the media resources reservation time, and the number of transmission opportunities of a wireless communication device having a long media resources reservation time can be reduced.

When the load placed on the wireless communication network is high, the media-resources-used-time management unit may increase the amount by which the media resources reservation time is added to the media resources used time. With this structure, in a system in which transmission is restricted when the media resources used time becomes long, the amount by which the media resources reservation time is added is set to a large value when the load placed on the wireless communication network is high. Therefore, the number of transmission opportunities of a wireless communication device that has reserved an excessive amount of media resources can be reduced.

The media-resources-used-time management unit may add to the media resources used time a value determined by subtracting a media resources used time involved for the communication destination node from the media resources reservation time to update the media resources used time. With this structure, by subtracting a media resources used time involved for the communication destination node, a media resources used time involved for the wireless communication device can be accurately determined.

The wireless communication device may further include a transmission opportunity reduction control unit configured to reduce the number of transmission opportunities when the media resources used time exceeds a predetermined threshold value. With this structure, when the media resources used time exceeds a predetermined threshold value, the number of transmission opportunities is reduced. Thus, transmission opportunities can equally be assigned to devices within a network.

According to another embodiment of the present invention, a bandwidth-reservation wireless communication system includes a transmitting device and a receiving device, the transmitting device and the receiving device being connected via a wireless communication network. The transmitting device includes a traffic amount estimation unit configured to estimate an amount of traffic involved in receiving response data from the receiving device, and a media resources reservation unit configured to reserve media resources on the basis of the estimated amount of traffic.

With this structure, in a bandwidth-reservation wireless communication system in which a transmitting device and a receiving device are connected via a wireless communication network, the transmitting device estimates an amount of traffic involved in receiving response data from the receiving device, and reserves media resources on the basis of the estimated amount of traffic. Therefore, a minimum amount of media resources can be reserved according to response data from the communication destination node. This can prevent a greater amount of media resources than an actually used amount of media resources from being reserved, and can reliably prevent a reduction in the number of transmission opportunities of other nodes.

According to still another embodiment of the present invention, a wireless communication method for a bandwidth-reservation wireless communication device that performs communication with a communication destination node connected thereto via a wireless communication network includes the steps of estimating an amount of traffic involved in receiving response data from the communication destination node, and reserving media resources on the basis of the estimated amount of traffic.

With this structure, in a wireless communication method for a bandwidth-reservation wireless communication device that performs communication with a communication destination node connected thereto via a wireless communication network, an amount of traffic involved in receiving response data from the communication destination node is estimated, and media resources are reserved on the basis of the estimated amount of traffic. Therefore, a minimum amount of media resources can be reserved according to response data from the communication destination node. This can prevent a greater amount of media resources than an actually used amount of media resources from being reserved, and can reliably prevent a reduction in the number of transmission opportunities of other nodes.

According to still another embodiment of the present invention, a program for a bandwidth-reservation wireless communication device that performs communication with a communication destination node connected thereto via a wireless communication network causes a computer to function as means for estimating an amount of traffic involved in receiving response data from the communication destination node, and means for reserving media resources on the basis of the estimated amount of traffic.

With this structure, in a program for a bandwidth-reservation wireless communication device that performs communication with a communication destination node connected thereto via a wireless communication network, an amount of traffic involved in receiving response data from the communication destination node is estimated, and media resources are reserved on the basis of the estimated amount of traffic. Therefore, a minimum amount of media resources can be reserved according to response data from the communication destination node. This can prevent a greater amount of media resources than an actually used amount of media resources from being reserved, and can reliably prevent a reduction in the number of transmission opportunities of other nodes.

According to an embodiment of the present invention, a transmitter reserves a minimum amount of media resources, whereby transmission opportunities can equally be assigned to nodes within a network.

### BRIEF DESCRIPTION OF THE DRAWINGS

FIG. 1 is a schematic diagram showing transmission and reception of packet data according to the reverse direction protocol;

FIG. 2 is a schematic diagram showing processing blocks operable to perform a process according to the reverse direction protocol;

FIG. 3 is a flowchart showing a process of the initiator (STA-A) according to the reverse direction protocol;

FIG. 4 is a flowchart showing a process of the responder (STA-B) according to the reverse direction protocol;

FIG. 5 is a schematic diagram showing a structure of a wireless communication network according to an embodiment of the present invention;

FIG. 6 is a schematic diagram showing processing blocks of the initiator and responder according to an embodiment of the present invention;

FIG. 7 is a schematic diagram showing a state of a TCP buffer of the initiator;

FIG. 8 is a flowchart showing a process of updating an output of a media resources calculation unit according to the value of a remaining buffer size (rsize[i]);

FIG. 9 is a flowchart showing a process of calculating an amount of reverse-direction (RD) traffic, which is performed by an RD traffic amount calculation unit, including first and second methods;

FIG. 10 is a flowchart showing a process of the initiator according to an embodiment of the present invention;

FIG. 11 is a flowchart showing a process of the responder according to an embodiment of the present invention;

FIG. 12 is a schematic diagram showing a method of sending an RD request indicating the amount of transmittable data from the responder to the initiator using reserved bits of the MAC header in the IEEE 802.11 frame format;

FIG. 13 is a schematic diagram showing an example of data format;

FIG. 14 is a schematic diagram showing transmission and reception of data between the TCP/IP layer and the MAC layer of the initiator, transmission and reception of data between the initiator and the responder, and transmission and reception of data between the MAC layer and the TCP/IP layer of the responder; and

FIG. 15 is a timing chart showing transmission and reception of data according to the CSMA/CA protocol.

### DESCRIPTION OF THE PREFERRED EMBODIMENTS

An exemplary embodiment of the present invention will now be described in detail with reference to the drawings. In the specification and drawings, components having substantially the same or similar functional structure are assigned the same reference numerals to omit redundant description thereof.

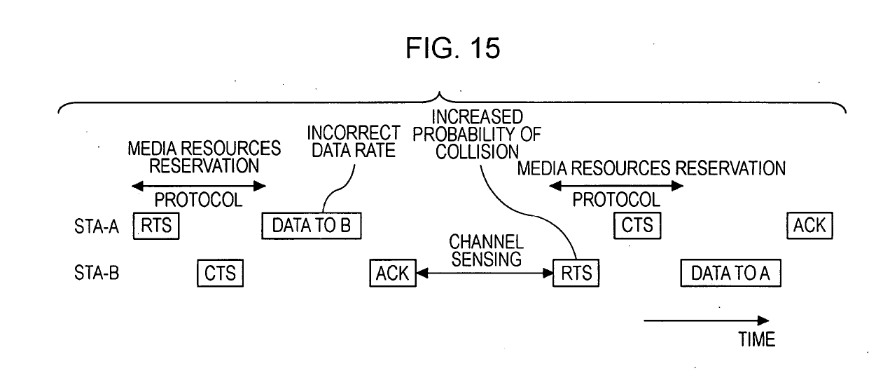

Before describing the embodiment, first, the reverse direction protocol in IEEE 801.11n will be described in detail. In order to perform bi-directional data transfer, individual nodes independently execute the process sequence described above with reference to FIG. 15. The reverse direction protocol specified in IEEE 802.11n provides a mechanism in which a transmitter requests a communication partner to transmit data in order to reduce the overhead of the protocol involved for the media resources reservation described above, the packet collision probability, etc.

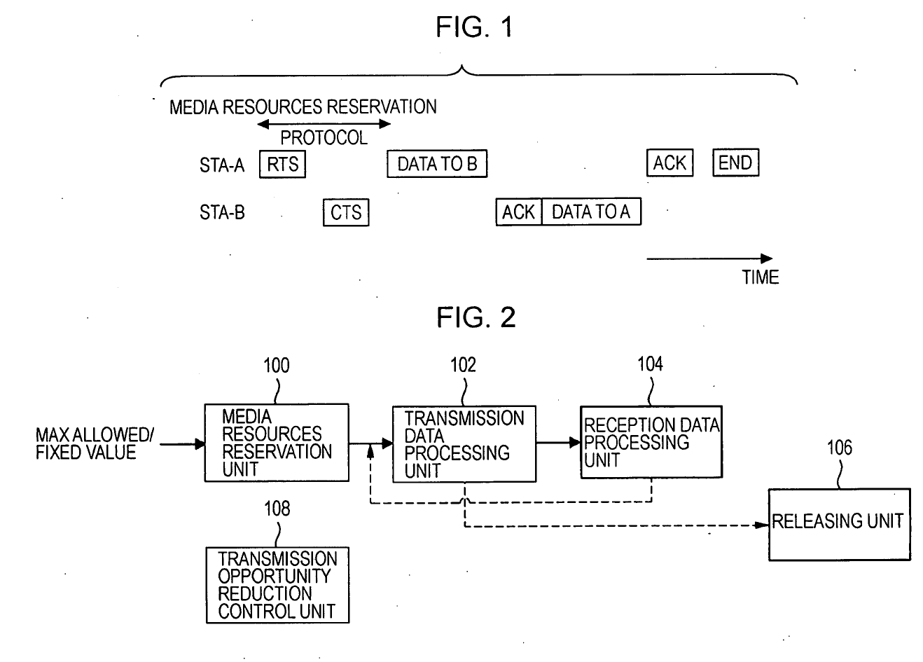

FIG. 1 is a schematic diagram showing transmission and reception of packet data according to the reverse direction protocol. First, an initiator (STA-A) transmits an RTS to a responder (STA-B), and receives a CTS to perform media resources reservation. Then, the initiator STA-A transmits a data packet (Data to B) to the responder STA-B. The data packet has a header including a flag indicating that the responder STA-B is permitted to perform transmission. In order to permit the responder STA-B to perform transmission, the media resources reserved at the time of transmission and reception of the RTS/CTS are sufficiently available.

Then, the responder STA-B receives the data packet, and detects the flag indicating the permission of transmission, which is included in the header. Then, the responder STA-B transmits an acknowledgement (ACK) in response to the reception of the data packet and a data packet (Data to A) to the initiator STA-A. This data packet may be referred to as “reverse direction (RD) data”. Then, the initiator STA-A transmits an ACK in response to the reception of the data packet from the responder STA-B. The initiator STA-A then transmits a notification packet (end (END) packet) for releasing reserved media resources.

In the reverse direction protocol, the header of the data packet (Data to B) transmitted from the initiator STA-A to the responder STA-B includes a 1-bit flag (RD) indicating that data transmission from the responder STA-B to the initiator STA-A is permitted. If the flag indicating the permission of transmission is included in the data (Data to B) transmitted from the initiator STA-A, the responder STA-B transmits an ACK and transmission data (Data to A) to the initiator STA-A. In the reverse direction protocol, as compared with FIG. 15, since no RTS or CTS is transmitted or received during the transmission from the responder STA-B to the initiator STA-A, the overhead and the packet collision probability can be reduced.

FIG. 2 is a schematic diagram showing processing blocks operable to perform a process according to the reverse direction protocol. In the processing blocks shown in FIG. 2, a control path indicating the order of control, namely, control in the Media Access Control (MAC) layer of a node, is illustrated. The configuration shown in FIG. 2 is common to an initiator (STA-A), which is a transmitting node, and a responder (STA-B), which is a receiving node. As shown in FIG. 2, the processing blocks include a media resources reservation unit (media reservation) 100, a transmission data processing unit (forward direction data) 102, a reception data processing unit (reverse direction data) 104, a releasing unit (exchange termination) 106, and a transmission opportunity reduction control unit (admission control) 108.

The media resources reservation unit 100 is configured to perform a process of making a reservation for media resources by transmitting and receiving an RTS and a CTS. The transmission data processing unit 102 is a block that performs a process of transmitting and receiving data sent from the initiator STA-A to the responder STA-B. In the initiator STA-A, the transmission data processing unit 102 performs a process of transmitting the data sent from the initiator STA-A to the responder STA-B. In the responder STA-B, the transmission data processing unit 102 performs a process of receiving the data received from the initiator STA-A.

The reception data processing unit 104 is a block that performs a process of transmitting and receiving data sent from the responder STA-B to the initiator STA-A. In the initiator STA-A, the reception data processing unit 104 performs a process of receiving the data received from the responder STA-B. In the responder STA-B, the reception data processing unit 104 performs a process of transmitting the data sent from the responder STA-B to the initiator STA-A.

The releasing unit 106 is a block that performs a process of transmitting an end (END) packet at the end of data transmission and reception. The transmission opportunity reduction control unit 108 is a block that compares a media resources reservation time with a time for which the media resources have been used to determine the availability of media resources.

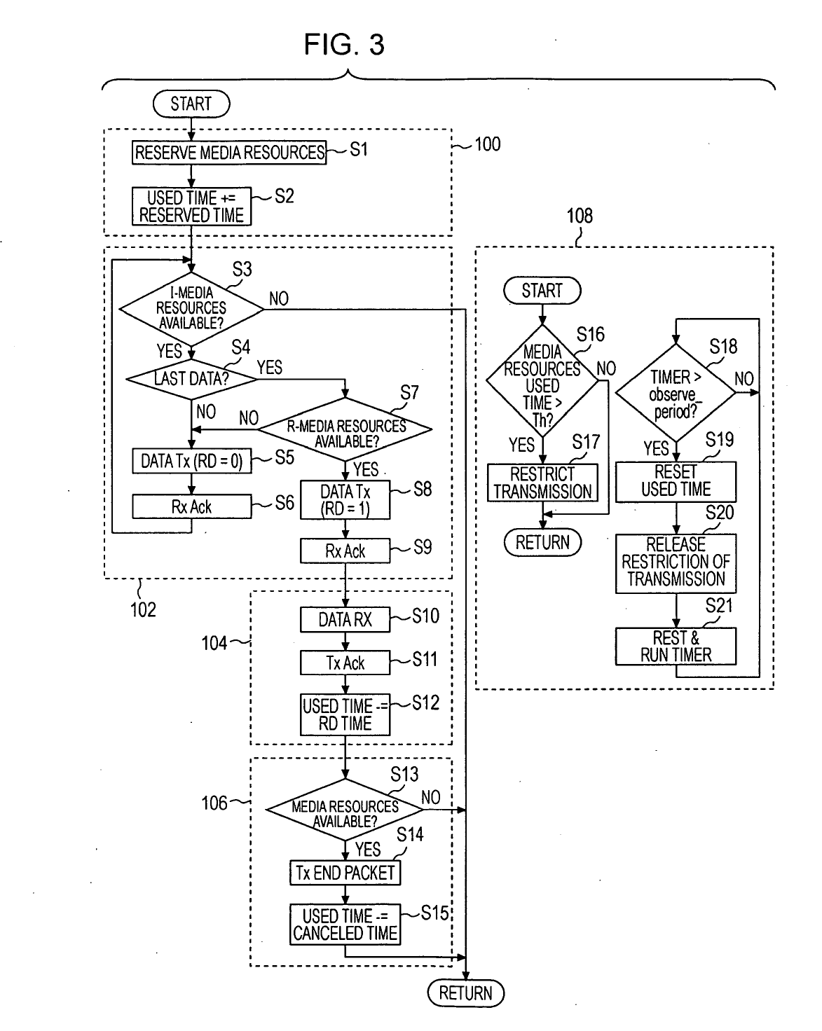

FIG. 3 is a flowchart showing a process of the initiator (STA-A) according to the reverse direction protocol. In FIG. 3, the steps and the blocks shown in FIG. 2 are illustrated in association with each other.

In the process shown in FIG. 3, first, the processing of steps S1 and S2 is performed by the media resources reservation unit 100 shown in FIG. 2. In step S1, an RTS is transmitted from the initiator STA-A to the responder STA-B, and the initiator STA-A receives a CTS from the responder STA-B to thereby reserve media resources based on transmission and reception of RTS/CTS. Then in step S2, a media resources reservation time reserved by the transmission and reception of RTS/CTS is added to a media resources used time (“used time”) obtained at the present time, which is a time for which the media resources have been used. Preferably, the media resources are reserved for a sufficient period of time to perform the subsequent processing.

Then, the processing of steps S3 to S9 is performed by the transmission data processing unit 102 shown in FIG. 2. In this processing, a data packet (Data to B) is transmitted from the initiator STA-A to the responder STA-B. The header of the data packet (Data to B) includes a flag (RD) indicating whether or not the responder STA-B is permitted to perform transmission. In order to permit the responder STA-B to perform transmission, the media resources reserved at the time of transmission and reception of RTS/CTS (step S1) are sufficiently available.

Specifically, in step S3, it is determined whether or not there are media resources available to transmit the data packet. If there are media resources available, the process proceeds to step S4. If there are no media resources available, the process ends (RETURN).

In step S4, it is determined whether or not the data packet to be transmitted is the last data. If the data packet to be transmitted is not the last data, the process proceeds to step S5, in which the data packet (Data to B) is transmitted to the responder STA-B (Data TX, where “TX” represents “transmit”). Since the data packet is not the last data, further data is to be continuously transmitted, and the responder (STA-B) is not permitted to perform transmission. Thus, the flag RD has a value of 0 (RD=0), and transmission from the responder STA-B is not permitted. Then in step S6, an ACK is received from the responder STA-B. Then, the process returns to step S3, and the processing described above is repeatedly performed. If it is determined in step S4 that the data packet to be transmitted is the last data, the process proceeds to step S7 in order to permit the responder (STA-B) to perform transmission. In step S7, it is determined whether or not there are media resources available to permit the responder (STA-B) to perform transmission.

If it is determined in step S7 that there are media resources available, the process proceeds to step S8, in which the last data packet is transmitted from the initiator STA-A to the responder STA-B (Data TX). In this case, the flag RD included in the header of the data packet is set to “1” (RD=1) in order to permit the responder STA-B to perform transmission. Then in step S9, an ACK is received from the responder STA-B (Rx Ack, where “RX” represents “receive”). If it is determined in step S7 that there are no media resources available, the process proceeds to step S5. In this case, in step S5, the last data is transmitted. Then, since it is determined in step S3 that there are no media resources available, the process ends (RETURN).

Then, the processing of steps S10 to S12 is performed by the reception data processing unit 104 shown in FIG. 2. In this processing, the initiator STA-A receives a data packet (RD data) transmitted from the responder STA-B. In step S10, the data packet transmitted from the responder STA-B is received (Data RX). In step S11, an ACK is transmitted to the responder STA-B (ACK TX).

Then in step S12, a period of time for which the RD data has been received (hereinafter referred to as “RD time”), which is involved in performing the processing of steps S10 and S11, is subtracted from the media resources used time obtained at the present time (Used Time minus (−=) RD Time). This is because a period of time for which the data packet was received in step S10 and a period of time for which the ACK was transmitted in step S11 are included in a media resources used time involved for the responder STA-B.

Then, the processing of steps S13 to S15 is performed by the releasing unit 106 shown in FIG. 2 to release the reserved media resources. First, in step S13, it is determined whether or not a certain amount of media resources reservation time remains at the present time. If a certain amount of media resources reservation time remains, then in step S14, an end packet is transmitted (Tx END Packet), and the remaining resources are released. By transmitting the end packet, the reserved media resources are released. If it is determined in step S13 that a certain amount of media resources reservation time does not remain, the process ends without transmitting an end packet (RETURN). In step S15, the amount of time canceled by transmitting the end packet is subtracted from the media resources used time obtained at the present time (Used Time minus (−=) Canceled Time). After the processing of step S15, the process ends (RETURN).

In step S2, the media resources reservation time is added to the media resources used time to update the media resources used time. In step S12, a media resources used time involved for the STA-B is subtracted from the updated media resources used time, and, in step S15, the canceled time is further subtracted so that the time corresponding to the released resources is returned. As a consequence, in the process of the initiator, the processing time involved in steps S3 to S9 is added to the media resources used time, which is obtained before the reserved media resources time is added in step S2, to update the media resources used time.

In FIG. 3, in addition to the process described above, a process performed by the transmission opportunity reduction control unit 108 is also illustrated. First, in step S16, it is determined whether or not the media resources used time obtained at the present time is greater than a predetermined threshold value Th. If the media resources used time is greater than the threshold value Th, in step S17, transmission is controlled to be restricted. Thus, a station that has used a large amount of media resources can be restricted to perform transmission.

The transmission opportunity reduction control unit 108 further performs a process of resetting the media resources used time. In this process, a timer is activated to measure a certain observation time. In step S18, it is determined whether or not the value of the timer exceeds an observation period (observe_period), which triggers a reset. If the value of the timer exceeds the observation period, the transmission opportunity reduction control unit 108 proceeds to step S19, and resets the media resources used time. If the value of the timer is not greater than the observation period, the transmission opportunity reduction control unit 108 stands by in step S18.

After the processing of step S19, the transmission opportunity reduction control unit 108 proceeds to step S20, and releases the restriction of transmission set in step S17. Then, in step S21, the count value of the timer is reset and the timer is restarted.

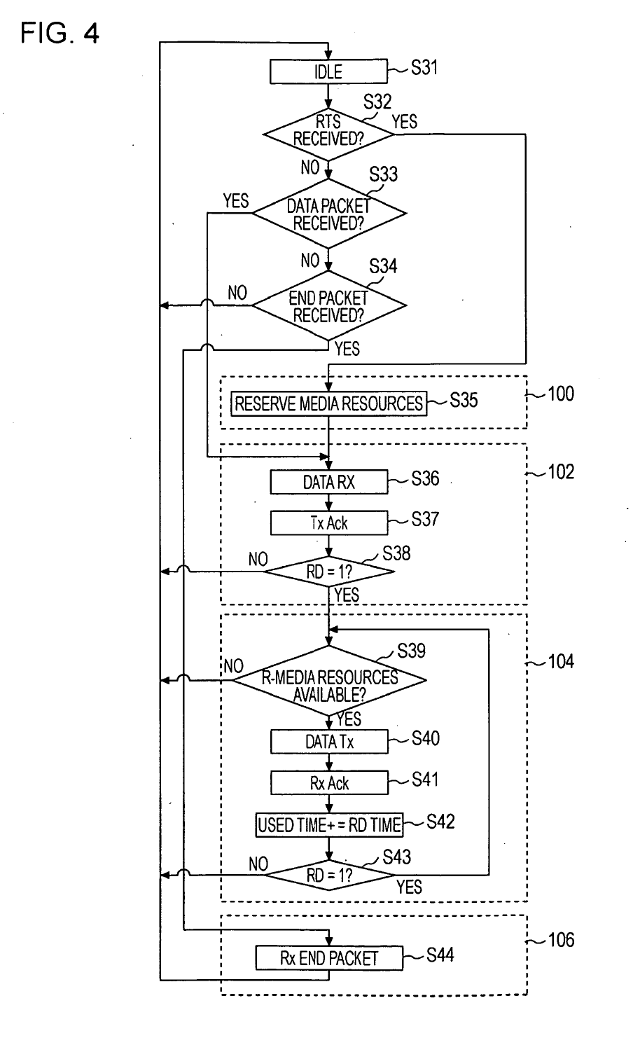

FIG. 4 is a flowchart showing a process of the responder (STA-B) according to the reverse direction protocol. In FIG. 4, the steps and the blocks shown in FIG. 2 are illustrated in association with each other. In the process of the responder STA-B, it is determined (steps S32, S33, and S34) whether or not a state transition has occurred from an idle state (step S31). The determination of the state transition is performed by determining whether or not an RTS has been received (step S32), whether or not a data packet has been received (step S33), and whether or not an end packet has been received (step S34). If it is determined in step S32 that an RTS has been received from the initiator STA-A, then in step S35, a CTS is returned, and media resources are reserved by the media resources reservation unit 100 of the initiator.

After media resources have been reserved in step S35, the process proceeds to step S36. If it is determined in step S33 that a data packet has been received from the initiator STA-A, the process proceeds to step S36.

The processing of steps S36 to S38 is performed by the transmission data processing unit 102 shown in FIG. 2. In this processing, first, in step S36, a process of receiving the data packet sent from the initiator STA-A is performed (Data RX). Then in step S37, an ACK is transmitted to the initiator STA-A (TX ACK). Then in step S38, it is determined whether or not the flag RD included in the header of the data packet transmitted from the initiator STA-A has a value of 1.

If it is determined in step S38 that the flag RD has a value of 1, this means that the responder is permitted to perform transmission, and the process proceeds to step S39. The processing of steps S39 to S43 is performed by the reception data processing unit 104 shown in FIG. 2. In step S39, it is determined whether or not a certain amount of media resources reservation time remains. If a certain amount of media resources reservation time remains, then in step S40, a data packet is transmitted (Data TX). Then in step S41, an ACK is received from the initiator STA-A in response to the packet data transmitted in step S40. In the processing of steps S39 to S41, the media resources have been used for a period of time corresponding to the RD time, and, in step S42, the RD time is added to a responder's media resources used time for which the media resources have been used by the responder to update the media resources used time (Used Time plus (+=) RD Time). Then in step S43, it is determined whether or not the flag RD has a value of 1. If it is determined in step S43 that the flag RD has a value of 1, this means that the responder STA-B is permitted to perform transmission, and the process returns to step S39. Then, the subsequent processing is performed again.

If it is determined in step S34 that an end packet has been received from the initiator STA-A, the process proceeds to step S44. In step S44, a process of receiving the end packet is performed (RX END Packet). The processing of step S44 is performed by the releasing unit 106 shown in FIG. 2. After the processing of steps S38, S39, S43, and S44, the media state become idle again.

In the reverse direction protocol described above, no RTS or CTS is transmitted or received when the responder transmits data, resulting in an implantation problem in that the initiator (STA-A) is not capable of detecting media resources (the presence of data, the amount of data, and the available transmission rate) necessary for the responder (STA-B). Thus, it is difficult to determine the amount of the media resources to be reserved during the reservation of media resources on the initiator side. Since it is difficult to estimate the amount of media resources to be reserved, as described above, a greater amount of media resources than an actually used amount of media resources may be reserved.

Another problem occurs in that the initiator (STA-A) is not capable of arbitrarily setting the data rate for transmission to the responder (STA-B). In order to reserve media resources, the initiator (STA-A) estimates the time involved for the initiator (STA-A) to transmit packets. In order to transmit all packets, it is necessary to transmit the packets using a transmission rate that is determined at the time of reservation of media resources (transmission and reception of RTS/CTS). However, in view of reasons that may cause a demand for an increased amount of media resources, such as in a case where it is necessary to reduce the transmission rate due to a change of transmission channel or in a case where retransmission is necessary due to an incorrect transmission channel, a greater amount of media resources than an actually used amount of media resources may be reserved.

Accordingly, at the time of the reservation of media resources in step S1 shown in FIG. 3 (step S35 shown in FIG. 4), media resources are reserved for a maximum amount of time according to a maximum media resources time that can be reserved or a predetermined fixed time. If media resources remain after the communication ends, an end packet is transmitted to release the reserved but unused media resources. However, there are problems with this technique in that, in addition to the reservation of an excessive amount of media resources, there may be a hidden node that does not successfully receive the end packet. A node within a network, which has successfully received the end packet, can detect the release of the media resources and can reserve new media resources. A hidden node, which has not successfully received the end packet, on the other hand, would not detect the completion of the use of the media resources and would not participate in making a reservation for media resources, resulting in unfairness of media resources reservation. In view of the presence of such a hidden node which does not successfully receive a media resources-releasing packet, it is preferable that an amount of media resources as close to an actually used amount of media resources as possible be reserved at the stage of transmission and reception of RTS/CTS.

In the WLAN specification, furthermore, a mechanism for restricting the amount of media resources used per unit time called Used Media Time is adopted in order to control the amount of media resources to be used by each node (Admission Control). That is, any further access to the media resources performed by a node that has used an amount of media resources greater than or equal to a certain amount of media resources (steps S16 to S21 shown in FIG. 3) is restricted, thus achieving fairness of media resources reservation for nodes within a basic service set (BSS). In the WLAN specification, the monitoring of only an actually used amount of media resources is specified. However, as described above, the release of reserved media resources is far from completeness, and the reservation of an excessive amount of media resources might, by itself, reduce the number of transmission opportunities of other nodes. Thus, only the management of a media resources used time for which the media resources were actually used is not sufficient to achieve media resources reservation fairness. Preferably, a protocol for imposing a penalty in a case where there is a difference between the amount of reserved resources and the amount of actually used resources is adopted.

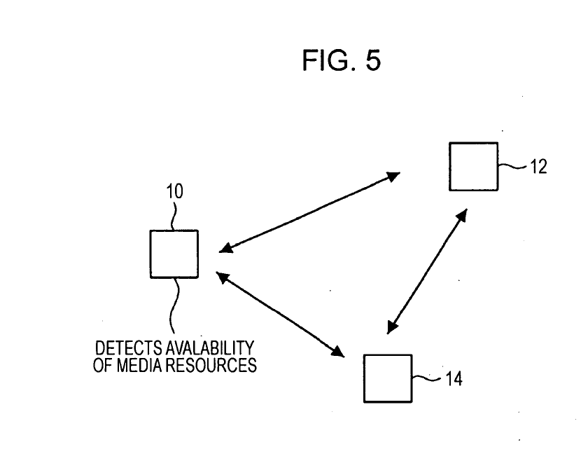

FIG. 5 is a schematic diagram showing a structure of a wireless communication network according to an embodiment of the present invention. The wireless communication network includes nodes 10, 12, and 14. Each of the nodes 10, 12, and 14 has functions of performing media resources reservation (allocation), transmitting data, and receiving data. A node that made a reservation for media resources is defined as an initiator, and a node serving as a communication partner communicating with the initiator is defined as a responder.

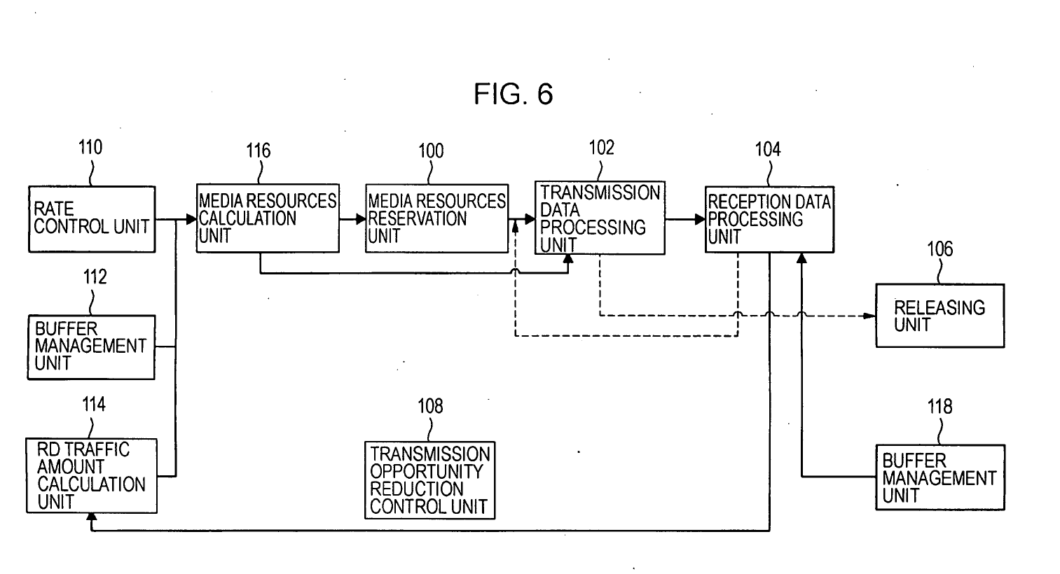

FIG. 6 is a schematic diagram showing processing blocks of each wireless communication device (initiator and responder) according to the present embodiment. The wireless communication device of the present embodiment performs processes based on the reverse direction protocol described above. The wireless communication device of the present embodiment includes a MAC layer, and a Transmission Control Protocol/Internet Protocol (TCP/IP) layer, which is an application layer higher than the MAC layer. In FIG. 6, as in the structure shown in FIG. 2, schematic processing blocks for MAC control are primarily shown. As shown in FIG. 6, the processing blocks of each of the initiator and the responder include a media resources reservation unit (Media reservation) 100, a transmission data processing unit (Forward Direction Data) 102, a reception data processing unit (Reverse Direction Data) 104, a releasing unit (Exchange Termination) 106, a transmission opportunity reduction control unit (Admission Control) 108, a rate control unit (Rate Control) 110, a buffer management unit (Buffer statistics) 112, an RD traffic amount calculation unit (RD traffic estimate) 114, a media resources calculation unit (Media estimate) 116, and a buffer management unit (Buffer statistics) 118.

In the structure of the present embodiment shown in FIG. 6, as is compared with that shown in FIG. 2, the rate control unit 110, the buffer management unit 112, the RD traffic amount calculation unit 114, the media resources calculation unit 116, and the buffer management unit 118 are provided in addition to the structure shown in FIG. 2.

In the present embodiment, the rate control unit 110 is a block that controls a transmission rate used for reservation of media resources, and is configured to calculate an average value of transmission rates (average transmission rate) to a transmission destination node (i.e., the responder). The average transmission rate may be, for example, an average value of transmission rates measured for a relatively long period of time.

The buffer management unit 112 is a functional block that manages a buffer of the initiator, and is configured to manage statistics of the storage of the amount of data to be transmitted to the responder. The buffer management unit 112 outputs an amount of data to be transmitted to the responder and the number of packets (buffer capacity). The buffer management unit 118 is also a functional block that manages a buffer of the responder, and has a function of calculating an amount of data to be transmitted from the responder and the number of packets (buffer capacity) in a case where the responder transmits data to the initiator. The initiator is notified of the buffer capacity of the responder calculated by the buffer management unit 118. The RD traffic amount calculation unit 114 outputs an amount of traffic (RD traffic) involved in receiving reverse direction (RD) data.

The media resources calculation unit 116 calculates the amount of media resources necessary to be reserved at the time of transmission and reception of RTS/CTS using media-resources-reservation transmission rate information output from the rate control unit 110, the buffer capacity output from the buffer management unit 112, and the amount of RD traffic output from the RD traffic amount calculation unit 114. The RTS/CTS sequence is executed via the determined amount of media resources.

As in the system shown in FIG. 2, the transmission data processing unit 102 performs a process of transferring data from the initiator to the responder. A transmission date rate or retransmission technique used in this process is not specifically limited, and a rate or retransmission technique suitable for the state of the transmission channel derived using an independent different algorithm can be used.

As in the system shown in FIG. 2, the reception data processing unit 104 processes data (RD Data) transmitted from the responder to the initiator. The responder further has a function of notifying the initiator of the amount of transmittable data in order to most efficiently perform reverse direction. The notification of the amount of data can be implemented using, for example, in the IEEE 802.11 frame format, reserved bits (RESERVE BIT) of the MAC.header.

The releasing unit 106 performs a process similar to that in the system shown in FIG. 2. In the present embodiment, in a case where reserved media resources are released using an end packet, the released resources are not directly returned but are corrected with a coefficient “alpha” and before they are returned. The coefficient alpha (where 0<alpha<1.0) is adjusted depending on media availability (media occupancy rate) and bandwidth availability. A centralized management function such as an access point (AP) controls the value of the coefficient alpha according to the number of users, channel occupancy rate, etc., and reports the value of the coefficient alpha to the nodes 10, 12, and 14 within the network. Alternatively, one of the nodes 10, 12, and 14 within the network may control the value of the coefficient alpha according to the number of users, channel occupancy rate, etc. In FIG. 5, the node 10 detects media availability, and controls the coefficient alpha. In the control of the coefficient alpha, the busier the media and the bandwidth, the closer to zero the coefficient alpha becomes.

In the system of the present embodiment having the configuration described above, the RD traffic amount calculation unit 114 calculates an amount of RD traffic. The amount of RD traffic is an indication of media weight, and represents an amount of traffic involved when RD data is transmitted from the responder. The higher the amount of RD traffic, the more media resources are allocated to the responder. This ensures that the initiator, when communicating with the responder, can optimally reserve media resources according to the communication status. The amount of RD traffic can be represented by a time (RD time) involved when RD data is transmitted and a value (fact) indicating the ratio of the amount of received data to the amount of data transmitted from the node (initiator).

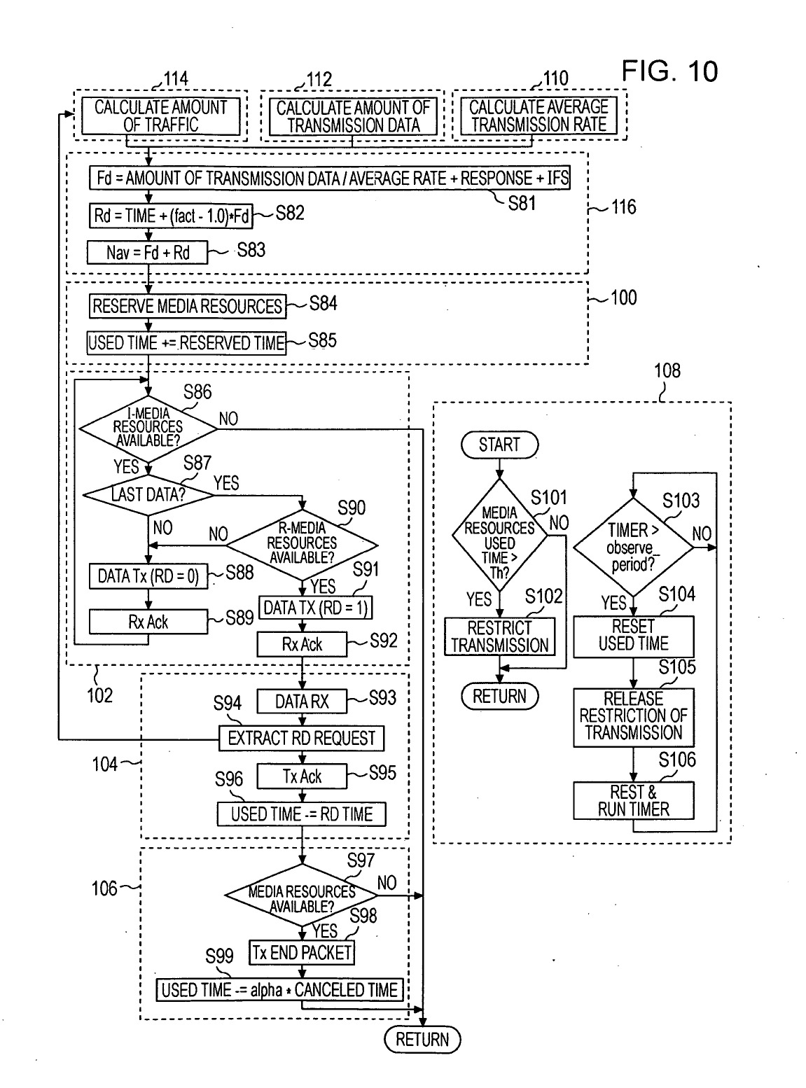

The RD traffic amount calculation unit 114 may determine an amount of RD traffic using two methods. The first method is to determine an output value of the amount of RD traffic on the basis of a value (RD request) reported from the responder. In this case, the initiator outputs an amount of RD traffic according to an RD request value. The RD request value is extracted from reverse direction data in step S94 shown in FIG. 10, which will be described below.

The second method is to determine an amount of RD traffic using auxiliary information regarding an application. In this case, it is assumed that a method of calculating an amount of RD traffic according to an application type and a method of deriving an amount of RD traffic when the TCP/IP protocol is used are adopted.

In the method of deriving an amount of RD traffic according to an application type, the amount of data to be sent from the responder, relative to the amount of data sent from the initiator, is determined according to the type of an application. For example, in interactive applications such as television (TV) phone and Voice over Internet Protocol (VoIP), the amount of transmission data transmitted from a given node and the amount of data received by the given node are substantially equal to each other. In other application types, on the other hand, the amount of data transmitted from the node can be multiplied by a predetermined coefficient to determine the amount of received data. Thus, the RD traffic amount calculation unit 114 outputs the ratio of the amount of data received by the node (initiator) to the amount of data transmitted from the node (initiator) according to the application type. The application type can be obtained from the TCP/IP layer higher than the MAC layer.

In the method of deriving the amount of traffic when the TCP/IP protocol is used, an acknowledgement (TCP_ACK) in response to transmission data is predicted to allocate media resources. The TCP_ACK can be estimated from the state of the TCP buffer, and the amount by which resources are allocated is variably determined according to the remaining capacity of the TCP buffer of the partner node.

Specifically, the initiator monitors the remaining capacity of the TCP buffer of the responder, makes a reservation for media resources, and allocates media resources to the partner node. The operation of the TCP buffer is defined in RFC (request for comments) 793.

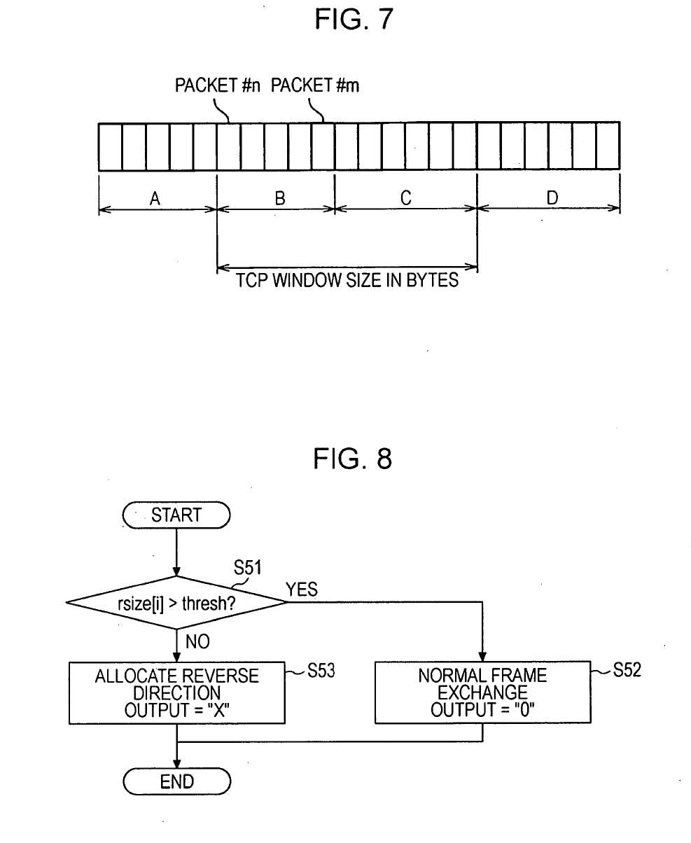

FIG. 7 is a schematic diagram showing a state of the TCP buffer of the initiator. In FIG. 7, a region A is a packet region indicating that packet data contained in the region A was transmitted to the responder in response to which an acknowledgement ACK has been returned from the responder. A region B is a packet region indicating that packet data in the region B was transmitted to the responder in response to which an acknowledgement ACK has not been returned from the partner node. A region C is a packet region including packets that are to be transmitted. A region D is a packet region including packets that are not allowed by the protocol to be transmitted. The state of the TCP buffer shown in FIG. 7 is updated when the initiator transmits a packet or when the initiator receives a new acknowledgement ACK from the responder.

In FIG. 7, the capacity of a region including the regions B and C corresponds to a window size of the TCP buffer (TCP window size). The packet data contained in the region C is ready to be transmitted, and the capacity of the region C can be defined as a remaining buffer capacity of the responder. Specifically, the remaining buffer capacity of the responder may be equal to the difference between the buffer size of the TCP buffer and the region B shown in FIG. 7 indicating a region of the transmitted packets, and may be represented by Equation (1) as fellows:

$$r size [ i ] = buff size [ i ] - {\sum }_{j = n}^{m} packet\_size [ j ] [ byte ] \qquad ( 1 )$$

where buffsize[i] denotes a buffer size corresponding to the window size of the TCP buffer reported from the responder, which is the transmission partner. The buffer size is updated each time an acknowledgement ACK is received from the responder. In Equation (1), the sigma (Σ) term provides a summation operation of the size (packet_size) of packets #n to #m shown in FIG. 7, and represents the capacity of the packet data contained in the region B shown in FIG. 7.

In Equation (1), the variable i indicates that the buffer size (buffsize[i]) and the remaining buffer size rsize[i] vary with time because the buffer size is updated each time an ACK is returned. In Equation (1), the sizes of the transmitted packets are summed, by way of example. Alternatively, a packet to be subsequently transmitted may also be included to perform calculation.

In order to reduce the overhead for the transmission of ACKs, the responder returns an ACK when the remaining buffer capacity becomes low. In other words, when the remaining buffer capacity is low, it can be determined that data packets, as well as an ACK, are more likely to be transmitted from the responder. The remaining buffer size rsize[i] determined by Equation (1) corresponds to the remaining capacity of the TCP buffer of the responder. Thus, it is found that, as the remaining capacity of the TCP buffer of the responder is low and the remaining buffer size rsize[i] has a small value, an ACK is more likely to be transmitted and the amount of RD traffic increases. In this present embodiment, therefore, when the remaining buffer size rsize[i] has a small value, a great amount of media resources are reserved for transmitting RD data to reserve reverse direction resources.

FIG. 8 shows a process of updating the output of the RD traffic amount calculation unit 114 according to the value of the remaining buffer size rsize[i] determined in Equation (1). First, in step S51, it is determined whether or not the remaining buffer size rsize[i] determined by Equation (1) exceeds a predetermined threshold value (thresh). If the remaining buffer size rsize[i] exceeds the predetermined threshold value, then in step S52, the output of the media resources calculation unit 116 is set to “0” (Normal Frame Exchange). In this case, since the value of the remaining buffer size rsize is relatively large, it can be determined that no ACK will be returned from the responder for a certain period of time and that the amount of RD traffic is small. Therefore, the setting for normal frames is performed, and the RD time is set to “0”.

If it is determined in step S51 that the remaining buffer size rsize[i] is not greater than the predetermined threshold value (thresh), the process proceeds to step S53, in which the RD time output from the RD traffic amount calculation unit 114 is set to a value x in milliseconds (ms). Thus, a larger amount of media resources are assigned to the returning of the RD data by the responder.

According to the process shown in FIG. 8, therefore, the output of the RD traffic amount calculation unit 114 is updated according to the value of the remaining buffer size rsize[i]. This ensures that media resources can be reserved according to the amount of traffic.

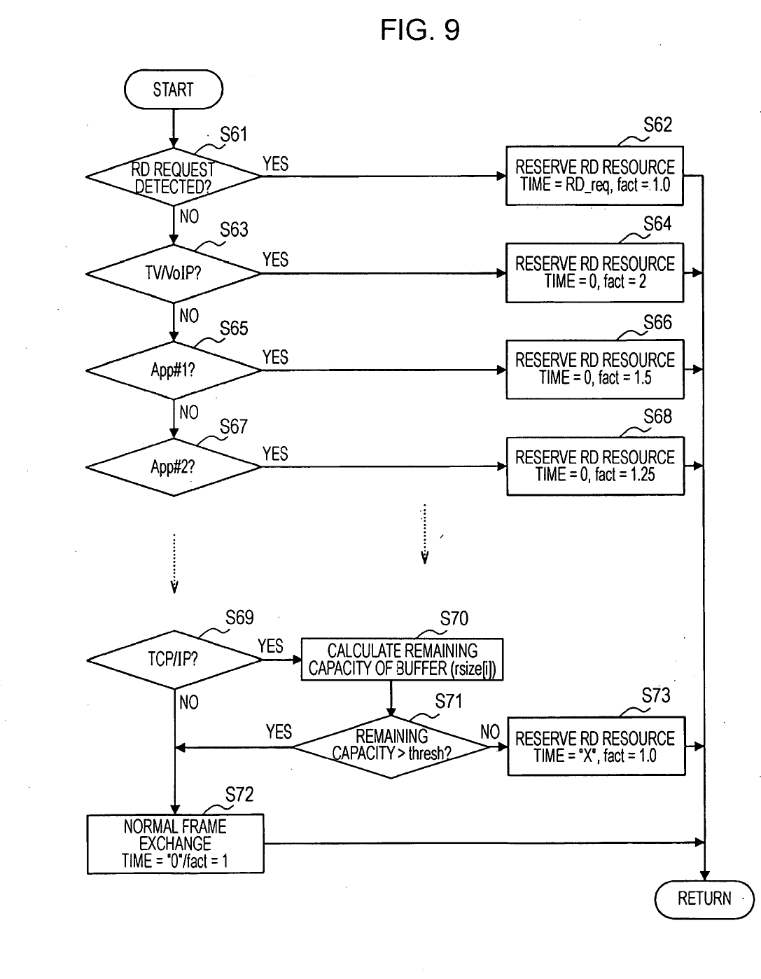

FIG. 9 is a flowchart showing a process of determining an amount of RD traffic, which is performed by the RD traffic amount calculation unit 114, including the first and second methods described above. The processing of steps S61 and S62 is processing of determining an output value of the amount of RD traffic on the basis of the value reported from the responder using the first method described above. The processing of steps S63 to S68 is processing of determining an amount of RD traffic according to an application type using the second method described above. The processing of steps S69 to S73 is processing of deriving an amount of RD traffic when the TCP/IP protocol is used.

First, in step S61, it is determined whether or not there is an RD request. If there is an RD request, the process proceeds to step S62, in which the RD time is set to a request time (RD_req) specified by the RD request, and the value (fact) indicating the ratio of the amount of received data to the amount of data transmitted from the node (initiator) is set to 1.0.

If it is determined in step S61 that there is no RD request, the process proceeds to step S63, in which it is determined whether or not the application type is TV phone or VoIP. If the application type is TV phone or VoIP, the process proceeds to step S64. In step S64, the RD time is set to 0, and the fact is set to 2.

If it is determined in step S63 that the application type is not TV phone or VoIP, the process proceeds to step S65, in which it is determined whether or not the application type is another application type (App#1). If the application type is the application type App#1, the process proceeds to step S66. In step S66, the value of the RD time is set to 0, and the fact is set to a value (=1.5) corresponding to the application type (App#1).

If it is determined in step S65 that the application type is not the application type App#1, the process proceeds to step S67. In step S67, it is determined whether or not the application type is still another application type (App#2). If the application type is the application type App#2, the process proceeds to step S68. In step S68, the RD time is set to 0, and the ratio (fact) is set to a value (=1.25) corresponding to the application type (App#2).

The values of the RD time and the fact are set in a manner similar to that described above under various conditions. Then, in step S69., it is determined whether or not the TCP/IP protocol is used. If the TCP/IP protocol is used, the process proceeds to step S70. In step S70, the remaining buffer capacity rsize[i] is determined, and the reprocess proceeds to step S71. The process subsequent to step S71 is similar to the process described with reference to FIG. 8.

In step S71, it is determined whether or not the remaining buffer capacity rsize[i] exceeds a predetermined threshold value (thresh). If the remaining buffer capacity rsize[i] is greater than the threshold value, the process proceeds to step S72. In step S72, the value of the RD time is set to 0, and the fact is set to 1.0. If the remaining buffer capacity rsize[i] is not greater than the threshold value, the process proceeds to step S73, in which the RD time is set to a value x in milliseconds (ms), and the fact is set to 1.0.

When the RD time and the value (fact) are determined in the manner described above and are output from the RD traffic amount calculation unit 114, the media resources calculation unit 116 sets a transmission prohibition period called NAV (Network Allocation Vector) based on the RD time and the value (fact), and the media resources reservation unit 100 makes a reservation for media resources. A process performed by the system of the present embodiment, including this media resources reservation process will be described with reference to FIG. 10. The process shown in FIG. 10 is executed by the initiator, and is performed in a manner similar to a portion of the process shown in FIG. 3.

In the process shown in FIG. 10, in steps S81 to S83, the amount of media resources to be reserved is determined by the media resources calculation unit 116. In this processing, the amount of RD traffic calculated by the RD traffic amount calculation unit 114, the amount of transmission data calculated by the buffer management unit 112, and the average transmission rate calculated by the rate control unit 110 are used.

In the determination of media resources using the media resources calculation unit 116, first, in step S81, the value of a transmission time Fd spent by the initiator is determined. The transmission time Fd is determined by the following equation:

Fd=amount of transmission data/average transmission rate+response time(Response)+IFS

where “response time” represents a time involved for response during transmission, and IFS denotes the frame interval time of a packet.

Then in step S82, a transmission time Rd spent by the responder is determined by the following equation:

Rd=RD time+(fact−1.0)*Fd

where the values of the RD time and the fact are set according to the processes shown in FIGS. 8 and 9 in the manner described above. As described above with reference to FIG. 9, in the first method, the RD time is set to the request value (RD_req) sent from the responder. In this case, since the fact is set to 1 (fact=1), the second term in the above equation for determining the transmission time Rd is equal to 0. The transmission time Rd is therefore set to the request value sent from the responder.

In a case where the RD time is set according to the application type using the second method, the first term of the above equation is equal to 0 because the RD time is set to 0. In this case, since the ratio (fact) is set to a value such as 2, 1.5, or 1.25, the value of the transmission time Rd is determined according to the second term of the above equation. For example, in a case where the application type is a TV phone, the amount of data transmitted from a given node and the amount of data received by the given node are substantially equal to each other. Thus, in step S64 shown in FIG. 9, the fact is set to 2. Therefore, with the second term of the above equation, the transmission time Fd of the initiator and the transmission time Rd of the responder are set to the same value.

Then in step S83, the transmission prohibition period Nav is determined by the following equation:

Nav=Fd+Rd

The processing of steps S84 and S85 is performed by the media resources reservation unit 100. The processing of steps S84 and S85 is basically similar to the processing of steps S1 and S2 shown in FIG. 3, respectively, and a media resources reservation time is set to the transmission prohibition period Nav determined in step S83. Thus, a media resources reservation time can be set according to the amount of used media resources, which is estimated from the amount of RD traffic.

Then, the processing of steps S86 to S92 is performed by the transmission data processing unit 102. The processing of steps S86 to S92 is basically similar to the processing of steps S3 to S9 shown in FIG. 3, respectively.

Then, the processing of steps S93 to S96 is performed by the reception data processing unit 104. The processing of steps S93, S95, and S96 is similar to the processing of steps S10, S11, and S12 shown in FIG. 3, respectively. In the process shown in FIG. 10, in step S94, an RD request to be sent to the RD traffic amount calculation unit 114 is extracted from the data packet received from the responder. The extracted RD request is sent to the RD traffic amount calculation unit 114.

Then, the processing of steps S97 to S99 is performed by the releasing unit 106. The processing of steps S97 and S98 is similar to the processing of steps S13 and S14 shown in FIG. 3, respectively. In the process shown in FIG. 10, in step S99, a value determined by multiplying the canceled time by the coefficient alpha is subtracted from the media resources used time (Used Time minus (−=) alpha*Canceled Time).

As described above, the coefficient alpha is reported from an access point (AP) or a node within a network. The busier the media or bandwidth is, the closer to zero the value of the coefficient alpha becomes. Thus, the value to be subtracted from the media resources used time decreases as the media become busier, and the media resources used time is set to a large value.

In FIG. 10, the processing of steps S101 to S106 performed by the transmission opportunity reduction control unit 108 is similar to the processing of steps S16 to S21 shown in FIG. 3, respectively. In a case where media resources are canceled when the media are busy, in the processing of step S99, the media resources used time is set to a larger value, which more facilitates transmission restriction in step S102. Thus, a penalty based on transmission restriction can be imposed on a node that has canceled the media resources when the media are busy.

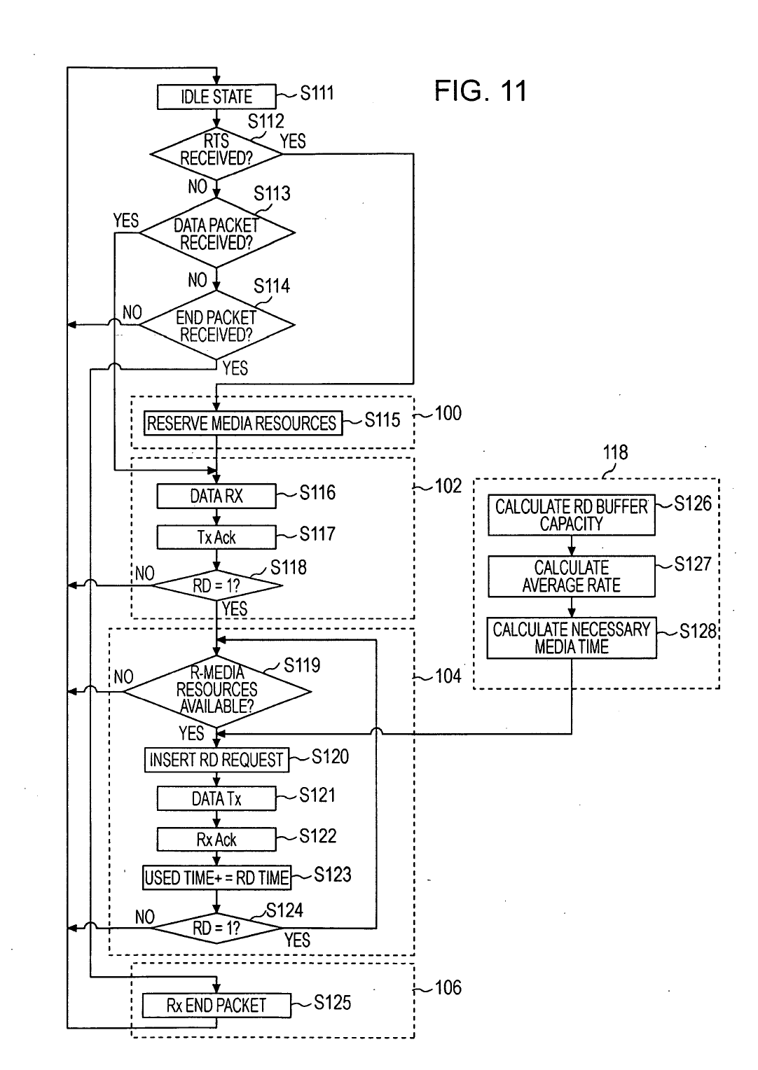

FIG. 11 is a flowchart showing a process of the responder according to the present embodiment. In FIG. 11, the processing of steps S111 to S119 is similar to the processing of steps S31 to S39 shown in FIG. 4, respectively. In the process shown in FIG. 11, in the media resources reservation processing of step S115, the initiator performs the process described above to reserve a certain amount of necessary media resources by taking the amount of RD traffic into account.

In the process shown in FIG. 11, the processing of steps S126 to S128 is performed by the buffer management unit 118 of the responder. First, in step S126, a buffer capacity is calculated. In step S127, an average transmission rate is calculated. Then in step S128, a media time (RD request) necessary for transmission from the responder is calculated form the buffer capacity and the average transmission rate.

Then in step S120, an RD request is inserted in the packet data to request the initiator to allocate media resources on the basis of the media time calculated in step S128. Then in step S121, the packet data having the RD request inserted therein is transmitted to the initiator. The subsequent processing of steps S122 to S125 is similar to the processing of steps S41 to S44 shown in FIG. 4, respectively.

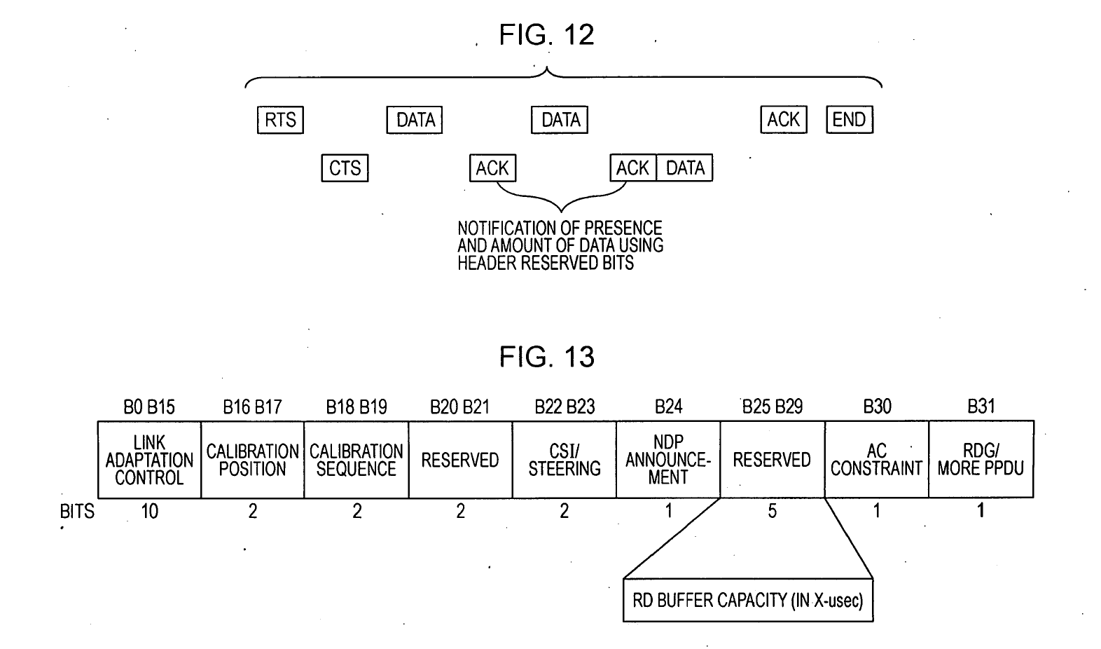

FIG. 12 is a schematic diagram showing a method of sending an RD request indicating the amount of transmittable data from the responder to the initiator using reserved bits of the MAC header in the IEEE 802.11 frame format. As shown in FIG. 12, an ACK transmitted from the responder includes header reserved bits. With the use of the header reserved bits, the initiator can be notified of the presence of data to be transmitted to the initiator and the amount of data. In FIG. 12, the first one of two ACKs transmitted from the responder has no accompanying data. Thus, the header reserved bits of the first ACK include information indicating no transmission data. The second transmitted ACK has accompanying data, and the header reserved bits of this ACK include information indicating that transmission data is present and information regarding the amount of data.

FIG. 13 is a schematic diagram showing an example of the data format. Specifically, for example, the high-throughput (HT) Control Field defined in the MAC header of IEEE 802.11n can be defined as shown in FIG. 13. Thus, the buffer capacity (i.e., RD request) of the responder (or initiator) can be reported.

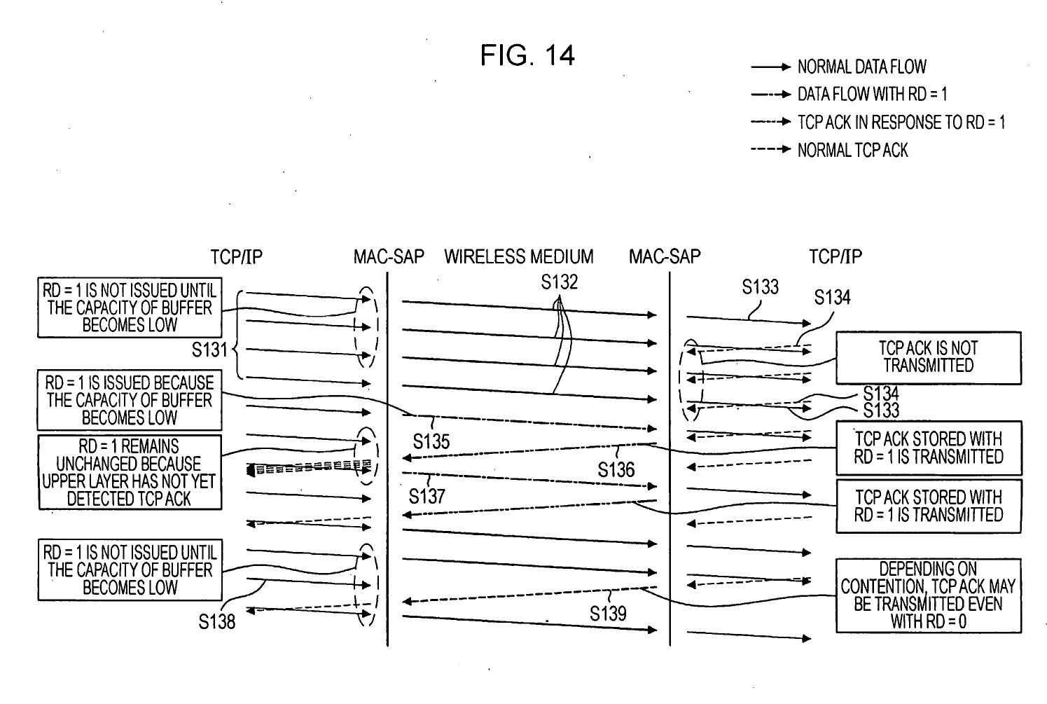

FIG. 14 is a schematic diagram showing transmission and reception of data between the TCP/IP layer and MAC layer of the initiator (STA-A), wireless transmission and reception of data between the MAC layer of the initiator and the MAC layer of the responder (STA-B), and transmission and reception of data between the MAC layer and TCP/IP layer of the responder.

Referring to FIG. 14, first, in step S131, data is transmitted from the TCP/IP layer to MAC layer of the initiator. In step S132, data is wirelessly transmitted from the MAC layer of the initiator to the MAC layer of the responder. At this time, in the TCP/IP layer of the initiator, the flag RD included in the data is not set to “0” until the remaining buffer capacity becomes low.

In the responder, in step S133, the data received from the MAC layer of the initiator is transmitted to the TCP/IP layer of the responder through the MAC layer. Upon receiving the data, the TCP/IP layer transmits an acknowledgement TCP_ACK to the MAC layer (step S134).

The MAC layer of the responder is not allowed to transmit an ACK to the initiator unless the flag RD included in the data from the initiator is set to “1”. Thus, the acknowledgement TCP_ACK transmitted from the TCP/IP layer of the responder to the MAC layer is stored in the MAC layer of the responder.

In the initiator, when the remaining capacity of the TCP buffer becomes low due to the transmission of data, in step S135, the flag RD included in the data to be transmitted to the responder is set to “1” and then the data is transmitted to the responder. Upon receiving the transmitted data with flag RD set to “1” (RD=1), in step S136, the responder transmits the acknowledgement TCP_ACK stored in the MAC layer to the initiator.

The TCP/IP layer has not yet detected the acknowledgement TCP_ACK at the time when the MAC layer of the initiator receives the acknowledgement TCP_ACK. Thus, in step S137, the data with the flag RD remaining unchanged (RD=1) is transmitted to the responder. Once the TCP/IP layer detects the acknowledgement TCP_ACK, the flag RD is set to “0”, and the data is transmitted to the responder (S138) in a manner similar to the in step S131.

As indicated in step S139, even if the value of the flag RD included in the data received by the responder is “0”, depending on the contention level, an acknowledgement TCP_ACK may be returned to the initiator.

While an exemplary embodiment of the present invention has been described with reference to the drawings, it is to be understood that the present invention is not limited to the foregoing embodiment. It is to be understood that various modifications or alterations may be made by persons skilled in the art without departing from the scope of the invention set forth in the appended claims, and it is anticipated that such modifications or alterations will also fall within the technical scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A bandwidth-reservation wireless communication device that performs communication with a communication destination node connected thereto via a wireless communication network, the wireless communication device comprising:
a traffic amount estimation unit configured to estimate an amount of traffic involved in receiving response data from the communication destination node; and
a media resources reservation unit configured to reserve media resources on the basis of the estimated amount of traffic.

2. The wireless communication device according to claim 1, further comprising:
a transmission-data amount calculation unit configured to calculate an amount of transmission data to be transmitted to the communication destination node;
an average transmission rate calculation unit configured to calculate an average transmission rate during transmission; and
a media resources calculation unit configured to calculate a media resources reservation time on the basis of the amount of traffic, the amount of transmission data, and the average transmission rate,
wherein the media resources reservation unit reserves media resources on the basis of the media resources reservation time calculated by the media resources calculation unit.

3. The wireless communication device according to claim 1, wherein the wireless communication device receives an acknowledgement in response to data transmitted to the communication destination node, and the response data from the communication destination node.

4. The wireless communication device according to claim 1, wherein the traffic amount estimation unit estimates the amount of traffic on the basis of a request value transmitted from the communication destination node.

5. The wireless communication device according to claim 1, wherein the traffic amount estimation unit estimates the amount of traffic on the basis of information transmitted from an application layer higher than a Media Access Control layer.

6. The wireless communication device according to claim 5, wherein the application layer is a Transmission Control Protocol layer, and
wherein the traffic amount estimation unit estimates the amount of traffic on the basis of a remaining capacity of a Transmission Control Protocol buffer included in the communication destination node.

7. The wireless communication device according to claim 6, wherein the traffic amount estimation unit calculates the remaining capacity of the Transmission Control Protocol buffer included in the communication destination node using a difference between a window size of the Transmission Control Protocol buffer and an amount of transmission data transmitted to the communication destination node in response to which an acknowledgement has not been returned.

8. The wireless communication device according to claim 5, wherein the traffic amount estimation unit estimates the amount of traffic according to an amount of transmission data to be transmitted to the communication destination node and a type of a communication application detected by the application layer.

9. The wireless communication device according to claim 8, wherein the traffic amount estimation unit calculates the amount of traffic by multiplying the amount of transmission data to be transmitted to the communication destination node by a coefficient that is set according to the type of the communication application.

10. The wireless communication device according to claim 2, wherein the media resources reservation unit includes a media-resources-used-time management unit configured to manage a media resources used time involved from the start of use of the media resources, and
wherein the media-resources-used-time management unit adds the media resources reservation time to the media resources used time to update the media resources used time, and adjusts an amount by which the media resources reservation time is added to the media resources used time according to a load placed on the wireless communication network.

11. The wireless communication device according to claim 10, wherein when the load placed on the wireless communication network is high, the media-resources-used-time management unit increases the amount by which the media resources reservation time is added to the media resources used time.

12. The wireless communication device according to claim 10, wherein the media-resources-used-time management unit adds to the media resources used time a value determined by subtracting a media resources used time involved for the communication destination node from the media resources reservation time to update the media resources used time.

13. The wireless communication device according to claim 10, further comprising a transmission opportunity reduction control unit configured to reduce the number of transmission opportunities when the media resources used time exceeds a predetermined threshold value.

14. A bandwidth-reservation wireless communication system comprising:
a transmitting device; and
a receiving device,
the transmitting device and the receiving device being connected via a wireless communication network,
wherein the transmitting device includes
a traffic amount estimation unit configured to estimate an amount of traffic involved in receiving response data from the receiving device, and
a media resources reservation unit configured to reserve media resources on the basis of the estimated amount of traffic.

15. A wireless communication method for a bandwidth-reservation wireless communication device that performs communication with a communication destination node connected thereto via a wireless communication network, the wireless communication method comprising the steps of:
estimating an amount of traffic involved in receiving response data from the communication destination node; and
reserving media resources on the basis of the estimated amount of traffic.

16. A program for a bandwidth-reservation wireless communication device that performs communication with a communication destination node connected thereto via a wireless communication network, the program causing a computer to function as:
means for estimating an amount of traffic involved in receiving response data from the communication destination node; and
means for reserving media resources on the basis of the estimated amount of traffic.
